(19) United States
(12) Patent Application Publication
(10) Pub. No.: US 2005/0152511 A1
(43) Pub. Date: Jul. 14, 2005

(54) Method and system for adaptively directing incoming telephone calls

(76) Inventor: Peter R. Stubley, Lachine (CA)

Correspondence Address: SMART & BIGGAR, Suite 3400, 1000 de la Gauchetiere Street West, Montreal, QC, H3B 4W5, CA

(21) Appl. No.: 10/755,374

(22) Filed: Jan. 13, 2004

(51) Int. Cl. H04M 1/64

(52) U.S. Cl. 379/88.01; 379/218.01

(57) ABSTRACT

A method and apparatus for identifying a called party suitable for use in an automated attendant system are provided. Information derived from a spoken utterance by a caller is received. Identification information associated to the caller is derived. The information derived from the spoken utterance is processed on the basis of a plurality of directory entries to identify at least one directory entry that is a potential match to the information derived from the spoken utterance. When multiple directory entries in the plurality of directory entries are potential matches to the information, a calling pattern associated to the identification information is identified and a most likely directory entry from the multiple directory entries is selected at least in part on the basis of the calling pattern. A signal conveying the selected directory entry is then released.

### FIELD OF THE INVENTION

The present invention relates to the field of automated attendant systems, and more specifically to a method and system for automatically directing incoming telephone calls by learning and adapting to calling patterns.

### BACKGROUND OF THE INVENTION

Automated attendant systems are commonly used in large enterprises for directing incoming calls to a department or individual. This is generally done by carrying on a short dialog with the caller in order to determine, on the basis of a caller's spoken utterances, to whom the caller would like to speak. As such, the automated attendant systems include speech recognition capabilities in order to process the caller's speech utterance in order to determine to whom the caller would like to speak. In order to determine to whom the caller would like to speak, the automated attendant system includes a plurality of directory entries that each correspond to a respective individual, department or service at that enterprise. Once the automated attendant system has made a determination, the automated attendant system connects the caller to the desired department or individual.

A deficiency with common automated attendant systems is that the system's ability to determine correctly to whom the caller would like to speak becomes more difficult when dealing with large directories. More specifically, when the size of a directory is quite large, the likelihood of ambiguity, meaning that the caller's utterance cannot be mapped to a single entry in the directory, increases. This ambiguity can happen in two manners; namely due to recognition ambiguity or caller ambiguity. Recognition ambiguity occurs when multiple directory entries have similar phonetic transcriptions that match the caller's spoken utterance, and the recognizer cannot reliably distinguish between them. For example, if a caller utters “john smith” and there is a John Smith and a Joan Smith in the directory, both entries will be a close match to the caller's utterance. The recognizer cannot confidently say whether the caller said “John Smith” or “Joan Smith.” The caller has provided the necessary information to complete the call, but the system cannot complete the call because of the recognition ambiguity. Caller ambiguity, on the other hand, occurs when the system cannot complete the call because the caller does not provide enough information to uniquely select a directory entry. In other words, caller ambiguity occurs when multiple directory entries match the caller's request. For example, if a caller asks for a “Mr Smith”, and there are three Mr. Smiths in the directory, then the caller's request is considered ambiguous, and once again the automated attendant system is unable to determine to whom the caller would like to speak. Another example would be when the caller says “John Smith,” and there are directory entries for “John Smith,” “Jon Smith,” and “John Smyth.”

Typical automated attendant systems resolve ambiguity by continuing the dialog with the caller until enough information is obtained. For example, the automated attendant system might ask the caller for the department in which the desired individual works, or the automated attendant system might present a plurality of options to the caller, and ask the caller to confirm the correct option. A deficiency with this process is that an extended dialog with the caller can be time consuming and sometimes irritating to the caller. As well, the extended dialog results in a longer call, which is more expensive in terms of the resources needed to support the system.

As such there is a need in the industry for an automated attendant system that is able to more efficiently direct an incoming call to a correct directory entry in the cases where there is an ambiguity.

### SUMMARY OF THE INVENTION

In accordance with a broad aspect, the present invention provides a method for identifying a called party. The method comprises receiving information derived from a spoken utterance by a caller and deriving identification information associated to the caller. The method further comprises processing the information derived from the spoken utterance on the basis of a plurality of directory entries to identify at least one directory entry that is a potential match to the information derived from the spoken utterance. When multiple directory entries in the plurality of directory entries are potential matches to the information, the method comprises identifying a calling pattern associated to the identification information and selecting a most likely directory entry from the multiple directory entries at least in part on the basis of the calling pattern. A signal conveying the selected directory entry is then released.

In accordance with another broad aspect, the present invention provides an apparatus that is suitable for use in an automated attendant system for identifying a called party in accordance with the above-described method.

In accordance with yet another broad aspect, the present invention provides a computer readable storage medium including a program element suitable for execution by a computing apparatus for identifying a called party in accordance with the above-described method.

In accordance with a broad aspect, the invention provides a method for identifying a called party. The method comprises receiving information derived from a spoken utterance by a caller and deriving identification information associated to the caller. The method further comprises processing the information derived from the spoken utterance on the basis of a plurality of directory entries in order to identify at least one directory entry that is a potential match to the information. When multiple directory entries in the plurality of directory entries are potential matches to the signal, the method comprises identifying a calling pattern associated to each of the directory entries that are potential matches to the information derived from the spoken utterance and selecting a most likely directory entry from the multiple directory entries at least in part on the basis of the identification information and the calling patterns associated to the multiple directory entries. The method further comprises releasing a signal conveying the selected directory entry.

In accordance with another broad aspect, the present invention provides an apparatus that is suitable for use in an automated attendant system for identifying a called party in accordance with the above-described method.

In accordance with yet another broad aspect, the present invention provides a computer readable storage medium including a program element suitable for execution by a computing apparatus for identifying a called party in accordance with the above-described method.

In accordance with a broad aspect, the invention further provides a method for identifying a called party. The method comprises providing a directory that includes a plurality of entries, the plurality of entries including at least one set of phonetically similar entries. The method further comprises receiving information derived from a spoken utterance by a caller, generating identification information associated to the caller and processing the information derived from the spoken utterance on the basis of the directory entries to identify at least one entry that is a potential match to the information. When multiple entries in the set of phonetically similar entries are potential matches to the information, the method comprises selecting a most likely entry from the set of phonetically similar entries at least in part on the basis of the identification information. Finally the method comprises releasing a signal conveying the selected directory entry.

In accordance with another broad aspect, the present invention provides an apparatus that is suitable for use in an automated attendant system for identifying a called party in accordance with the above-described method.

In accordance with yet another broad aspect, the present invention provides a computer readable storage medium including a program element suitable for execution by a computing apparatus for identifying a called party in accordance with the above-described method.

In accordance with another broad aspect, the present invention provides a method for identifying a called party. The method comprises receiving an utterance spoken by a caller, identifying a set of directory entries that are a potential match to the utterance spoken by the caller. The method also includes deriving identification information associated to the caller, wherein the identification information corresponds to a calling pattern. The method also includes selecting a most likely directory entry from the set of directory entries at least in part on the basis of the calling pattern. The method also comprises releasing a signal conveying the most likely directory entry.

In accordance with another broad aspect, the present invention provides a method for identifying a called party. The method comprises receiving an utterance spoken by a caller, identifying a set of directory entries that are a potential match to the utterance spoken by the caller. The method also includes deriving identification information associated to the caller.

The method also includes identifying a calling pattern associated to at least one of the directory entries that is a potential match to the spoken utterance, and selecting a most likely directory entry from the set of directory entries at least in part on the basis of the calling patterns. The method also comprises releasing a signal conveying the most likely directory entry.

In accordance with another broad aspect, the present invention provides a method for identifying a called party. The method comprises receiving an utterance spoken by a caller, identifying a set of phonetically similar directory entries, wherein each entry in the set is a potential match to the utterance spoken by the caller. The method also includes deriving identification information associated to the caller and selecting a most likely entry from the set of phonetically similar directory entries at least in part on the basis of the identification information. The method also comprises releasing a signal conveying the most likely directory entry.

In accordance with another broad aspect, the present invention provides a system for identifying a called party. The system comprises an automated speech recognition engine and a call directing unit. The automated speech recognition engine is adapted for processing an utterance spoken by a caller for deriving information therefrom. The call directing unit comprises an input for receiving information derived from the utterance spoken by a caller and a processing unit that is in communication with the input. The processing unit is operative for deriving identification information associated to the caller and processing the information derived from the spoken utterance on the basis of a plurality of directory entries to identify at least one directory entry that is a potential match to the information derived from the spoken utterance. When multiple directory entries in the plurality of directory entries are potential matches to the information derived from the spoken utterance, the processing unit identifies a calling pattern associated to the identification information and selects a most likely directory entry from the multiple directory entries at least in part on the basis of the calling pattern. The call directing unit further comprises an output for releasing a signal conveying the most likely directory entry.

In accordance with another broad aspect, the present invention provides an apparatus for identifying a called party. The apparatus comprises means for receiving information derived from an utterance spoken by a caller. The apparatus also comprises means for deriving identification information associated to the caller. The apparatus also comprises means for processing the information derived from the spoken utterance on the basis of a plurality of directory entries to identify at least one directory entry that is a potential match to the information derived from the spoken utterance. When multiple directory entries in the plurality of directory entries are potential matches to the information derived from the spoken utterance, the multiple directory entries are processed by means for identifying a calling pattern associated to the identification information and selecting a most likely directory entry from the multiple directory entries at least in part on the basis of the calling pattern. The apparatus further comprises means for releasing a signal conveying the most likely directory entry.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

A detailed description of the embodiments of the invention is provided herein below with reference to the following drawings, wherein:

FIG. 1 shows a diagram of an automated attendant system in accordance with a non-limiting embodiment of the present invention;

FIG. 2 shows a block diagram of a dialog manager in accordance with a non-limiting embodiment of the present invention;

FIG. 3 shows a flow diagram of a process for directing incoming calls when there is ambiguity, in accordance with a non-limiting embodiment of the present invention;

FIG. 4 shows a diagram of the automated attendant system of FIG. 1, wherein a calling pattern is associated to the caller, in accordance with a non-limiting embodiment of the present invention;

FIG. 5 shows a flow diagram of a process for directing incoming calls using the calling pattern shown in FIG. 4, in accordance with a non-limiting embodiment of the present invention;

FIG. 6 shows a diagram of the automated attendant system of FIG. 1, wherein calling patterns are associated with directory entries, in accordance with a non-limiting embodiment of the present invention;

FIG. 7 shows a flow diagram of a process for directing incoming calls using the calling patterns shown in FIG. 6, in accordance with a non-limiting embodiment of the present invention;

FIG. 8 shows a flow diagram of a process for generating a calling pattern associated with a caller, in accordance with a non-limiting embodiment of the present invention;

FIG. 9 shows a flow diagram of a process for generating calling patterns associated with directory entries, in accordance with a non-limiting embodiment of the present invention;

FIG. 10 shows a block diagram of a computing unit for implementing the functionality of the dialog manager shown in FIG. 2, in accordance with a non-limiting embodiment of the present invention.

In the drawings, embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

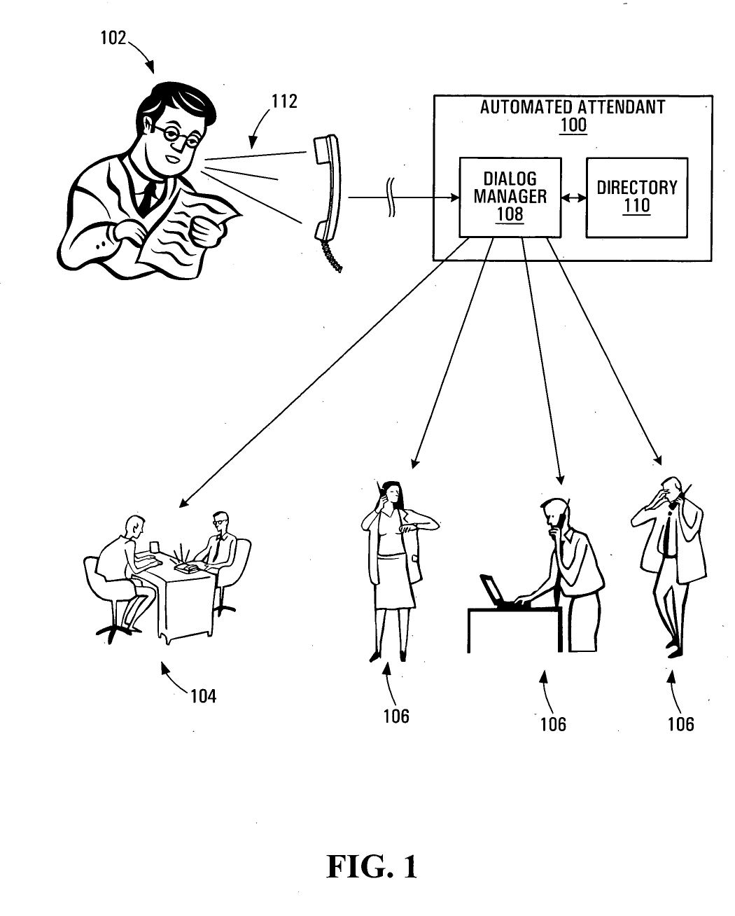

Shown in FIG. 1 is an automated attendant system 100 in accordance with a non-limiting example of implementation of the present invention.

The automated attendant 100 is an automated speech application that is adapted to be installed at an enterprise for directing incoming calls from callers 102, to individuals 106 or departments 104 within the enterprise. As shown in FIG. 1, the automated attendant 100 includes a dialog manager 108 and a directory 110. The dialog manager 108 is operative for engaging the caller 102 in a dialog in order to determine to whom the caller 102 would like to speak. More specifically, using the directory 110 and the information received from the caller 102 via the caller's spoken utterances 112, the dialog manager 108 is able to determine to whom the caller 102 would like to speak, and direct the caller 102 to that individual or department.

The directory 110 contains a plurality of directory entries that correspond to the departments 104 and/or individuals 106 within the enterprise. In a non-limiting example of implementation, the directory entries associated to the departments 104 may contain the name of the department and the phone number/extension number for that department. The directory entries associated to the individuals 106 may contain the name of the individual, the individual's phone number/extension number, and the department in which the individual works. It should be understood that more or less information can be included in each directory entry without departing from the spirit of the invention.

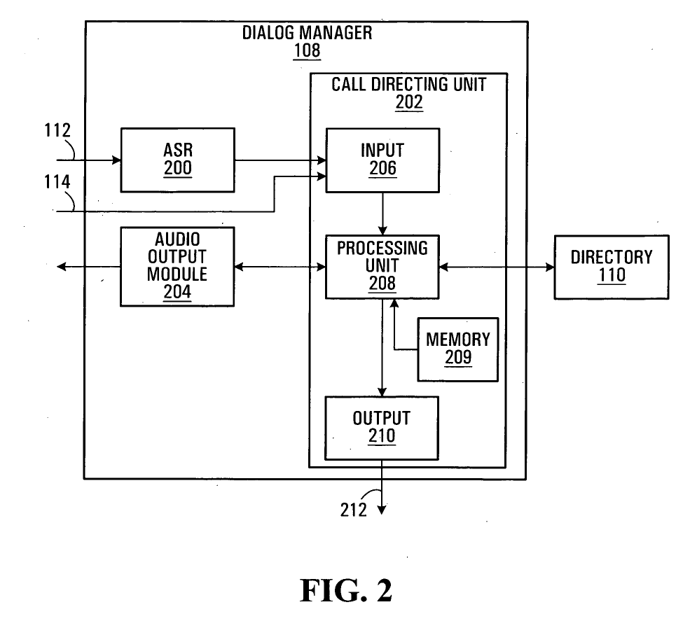

Shown in FIG. 2, is a block diagram of the dialog manager 108 in accordance with a non-limiting example of implementation of the present invention. The dialog manager 108 includes an automated speech recognition engine (ASR) 200, a call-directing unit 202 and an audio output module 204.

The ASR engine 200 is operative for receiving a caller's spoken utterance 112 and processing it in order to generate information derived from the caller's spoken utterance. For the purposes of the present description, the term “information derived from the caller's spoken utterance” refers to one or more recognition results associated to the spoken utterance. Any suitable ASR engine may be used for processing the speech signal and releasing a set of data elements including one or more candidate recognition results.

The information derived from the caller's spoken utterance is then passed to the call-directing unit 202. The call-directing unit 202 includes an input 206 for receiving the information derived from the caller's spoken utterance, a processing unit 208 and an output 210. The processing unit 208 is operative for processing the information derived from the caller's spoken utterance on the basis of the plurality of directory entries contained in the directory 110. In this manner, the processing unit 208 is able to identify one or more directory entries that are a potential match to the one or more recognition results derived from the caller's spoken utterance. In the case where there is only one potential match to the information derived from the caller's spoken utterance, the processing unit 208 outputs a signal 212 indicative of the matching directory entry and the dialog manager 108 connects the caller 102 to the individual 106 or department 104 corresponding to that directory entry.

However, in the case where there are multiple entries in the directory 110 that are a potential match to the information derived from the caller's spoken utterance, the processing unit 208 executes further steps in order to resolve the ambiguity. In a specific example, ambiguity occurs when the information derived from the caller's utterance 112 can be mapped to more than one directory entry within the directory 110.

In a first example of implementation where there is ambiguity, the processing unit 208 communicates with the audio output module 204, which communicates with the caller 102 in order to obtain further information from the caller 102 that will help to resolve the ambiguity. The audio output module 204 is a speech synthesizer that is able to convert information in a non-speech format into speech that is understandable by a human. As such, the audio output module 204 is able to ask questions to a caller in order to solicit further information. For example, in the case where the caller is trying to reach an individual 106, the audio output module 204 might ask the caller 102 to repeat the individual's name, or might ask for information about the individual, such as the individual's first name, or the department in which the individual works. In this manner the processing unit 208, in combination with the audio output module 204, is able to resolve the ambiguity. The following is a specific example of an interaction between the dialog manager 108 and a caller 102.
[dialog manager 108] For what name, please?
[caller 102] John Smith

Let us assume, for the sake of the present example, that there are five entries in the directory 110 that are a potential match to John Smith, and as such, in order to resolve this ambiguity, the audio output module 204 asks for further information.
[dialog manager 108] There are several entries for John Smith. Do you know their department?
[caller 102] No
[dialog manager 108] Do you know their location?
[caller 102] Montreal.

Assuming that only one of the five entries in the directory 110 is located in Montreal, the dialog manager 108 is able to route the caller 102 to the correct directory entry.
[dialog manager 108] Transferring you to John Smith in Montreal.

Alternatively, instead of soliciting further information from a caller 102, the audio output module 204 could list all the directory entries that are a potential match to the information derived from the caller's spoken utterance, and wait for confirmation from the caller 102. For example, the following interaction between the dialog manager 108 and the caller 102 could occur.
[dialog manager 108] For what name, please?
[caller 102] John Smith

Once again, let us assume that there are five entries in the directory 110 that are a potential match to John Smith, and as such, in order to resolve this ambiguity, the audio output module 204 needs further information.
[dialog manager 108]. There are several entries for John Smith. Would you like John
Smith in Parts?
[caller 102] No
[dialog manager 108] Would you like John Smith in Customer Service?
[caller 102] No
[dialog manager 108] Would you like John Smith in R&D?
[caller 102] Yes
[dialog manager 108] Transferring your call to John Smith in R&D.

The above two examples of resolving ambiguity by continuing a dialog with the caller 102, may be implemented by a person skilled in the art using any known techniques and as such will not be described in further detail herein.

In a second example of implementation where there is ambiguity, meaning that there are multiple directory entries that are a potential match to the information derived from the caller's spoken utterance, the processing unit 208 selects the most likely directory entry from the multiple directory entries on the basis of a calling pattern. This second example of implementation will be described in greater detail below.

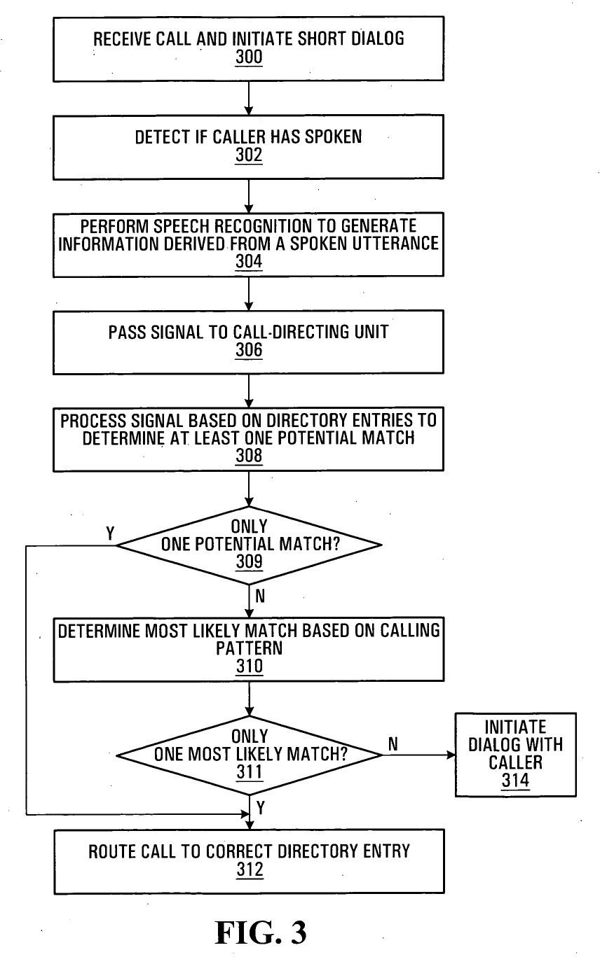

Shown in FIG. 3 is a flow chart that shows a non-limiting example of a process used by the dialog manager 108 in order to direct an incoming call. At step 300, the dialog manager 108 detects that a call is being received and initiates a short dialog with the caller 102. For example, upon detection of a received call, the audio output module 204 introduces the name of the enterprise and provides information to the caller 102 regarding the enterprise's address and operating hours. In addition, the audio output module 204 asks the caller to whom they would like to speak by asking a question such as “For what name, please?”.

At step 302, the ASR engine 200 detects whether the caller has spoken. At step 304, upon detection of a speech utterance by the caller 102, the ASR engine 200 generates information derived from the caller's spoken utterance, and passes that information to the input 206 of the call-directing unit 202. As mentioned above, the information derived from the spoken utterance may include one or more recognition results derived by the ASR 200 on the basis of the caller's spoken utterance 112.

In a non-limiting implementation, the ASR engine 200 returns several possible results corresponding to a caller's spoken utterance 112. These possible results are sometimes referred to as the N-best list and are typically ordered in decreasing order of likelihood. As such, the first result in the list is the most likely recognition result, and the second result in the list is the second most likely recognition result, and so on. The ASR engine 200 also assigns to each result in the N-best list a confidence measure, indicating the likelihood that the result is recognized correctly. A high confidence measure indicates that the recognition result is more likely to be correct than a recognition result having a low confidence measure. The confidence measures are used by the ASR engine 200 to determine whether to accept or reject a given recognition result. For example, recognition results having a confidence measure above a certain threshold would be accepted, and recognition results having a confidence measure below a certain threshold would be rejected.

For the sake of example, let us assume that a threshold confidence measure is 40%, wherein any recognition result that has a confidence measure less than 40% is rejected. As such, in a first example of implementation, in response to a spoken utterance of “John Smith”, the ASR engine 200 might generate an N-best list of 3 results, which contain the results of “John Smith”, “John Wish” and “John Fish”, wherein the first result has a confidence measure of 90% and the second and third results each have a confidence measure of 5%. In such a case, the ASR engine 200 would reject the second and third results, and the information derived from the spoken utterance would contain only the result of “John Smith”. In an alternative example of implementation, in response to the spoken utterance of “John Smith” the ASR engine 200 might generate an N-best list of 3 results, containing the results of “John Smith”, “Joan Smith” and “Tom Wish”, wherein the first result has a confidence measure of 47%, the second result has a confidence measure of 43% and the third result has a confidence measure of 10%. In such a case, the ASR engine 200 would reject the third result and the information derived from the spoken utterance would contain the two results of “John Smith” and “Joan Smith”. These two recognition results fall into the category of recognition ambiguity, since the ASR engine 200 is unable to recognize which result is the correct result. The situation where the ASR engine 200 would provide information derived from a spoken utterance that contains two recognition results, such as “John Smith” and “Joan Smith” might occur when the ASR engine 200 is unable to receive a clear spoken utterance. This may occur when there is bad reception with the caller such as when the caller 102 is calling from a location with a lot of background noise, or when the caller 102 is not pronouncing the words clearly.

ASR engines 200 that are capable of deriving recognition results and assigning confidence measures to those recognition results are known in the art, and as such, will not be described in greater detail herein.

Referring back to FIG. 3, in a non-limiting embodiment, at step 306, the ASR engine 200 passes the information derived from the spoken utterance to the input 206 of the call-directing unit 202. The input 206 then directs the information derived from the spoken utterance to the processing unit 208. At step 308, the processing unit 208 processes the information derived from the spoken utterance on the basis of the directory entries contained in the directory 110 in order to identify at least one directory entry that is a potential match to the information derived from the spoken utterance.

Continuing with the example presented above, in the case where the information derived from the spoken utterance contains only the recognition result of “John Smith”, the processing unit 208 processes this recognition result on the basis of the directory entries contained in the directory 110 in order to identify one or more directory entries that are a potential match to the recognition result of “John Smith”. In a specific example of implementation, the processing unit 208 identifies directory entries that are a potential match to the recognition result of “John Smith” by identifying directory entries that are phonetically similar to the recognition result. Different techniques in which the processing unit 208 identifies which directory entries are potential matches to the recognition results are known in the art, and as such, will not be described in more detail herein. In the case where the information derived from the spoken utterance contains more than one recognition result, such as “John Smith” and “Joan Smith”, the processing unit 208 processes each of these recognition results on the basis of the directory entries contained in the directory 110 in order to identify the directory entries that are a potential match to each one of “John Smith” and “Joan Smith”.

In a first example of implementation, there is only one potential match to the information derived from the spoken utterance. For example, in the case described above wherein the information derived from the spoken utterance contains the recognition result “John Smith”, the processing unit 208 might determine that there is only one directory entry in the directory 110 that is a potential match to that recognition result. Similarly, in the case where the information derived from the spoken utterance contains the two recognition results of “John Smith” and “Joan Smith”, the processing unit 208 might determine that there is only one directory entry that is a potential match to “John Smith” and no directory entries that are a potential match to “Joan Smith”. As such, referring back to FIG. 3, in the case where there is only one directory entry that is a potential match to the information derived from the spoken utterance at step 309, the processing unit 208 proceeds to step 312 at which point the processing unit 208 outputs a signal via output 210 that is indicative of the directory entry that was a match to the information derived from the spoken utterance. On the basis of this output signal, the dialog manager 108 is able to direct the incoming call to the individual or department that corresponds to the matching directory entry. Optionally, the audio output module 204 of the dialog manager 108 can ask the caller 102 for confirmation that the matching directory entry is the directory entry to whom the caller would like to be directed.

In a second example of implementation, there are multiple directory entries that are a potential match to the signal derived from the spoken utterance. Continuing with the example described above, in the case where the signal derived from the spoken utterance contains the recognition result “John Smith”, the processing unit 208 determines that the directory 110 includes a set of phonetically similar directory entries that are all potential matches to “John Smith”. For the sake of example, let us assume that there are 5 directory entries in the set of phonetically similar directory entries, wherein the set includes:
3 directory entries associated to individuals named “John Smith”, namely 1 John Smith in Sales, 1 John Smith in R&D and 1 John Smith in customer services;
1 directory entry associated to a “Jon Smith”; and
1 directory entry associated to a “Jon Smithe”.

It will be noticed that these directory entries are not only phonetically similar, but they are also phonemically identical, in that if they were to be uttered by a caller, they would all sound substantially the same. These entries fall into the category of “caller ambiguity” since the information provided by the caller is not sufficient to distinguish between these entries.

In the case where the signal derived from the spoken utterance contains the two recognition results of “John Smith” and “Joan Smith”, the processing unit 208 might determine that there are six directory entries that are a potential match to these recognition results. For example, the directory 110 might contain a set of five phonetically similar entries, as described above, that are a potential match to “John Smith” and one directory entry that is a potential match to “Joan Smith”. More specifically, the set of six phonetically similar directory entries might include:
3 directory entries associated to individuals named “John Smith”, namely 1 John Smith in Sales, 1 John Smith in R&D and 1 John Smith in customer services;
1 directory entry associated to a “Jon Smith”;
1 directory entry associated to a “Jon Smithe”; and
1 directory entry associated to a “Joan Smith”.

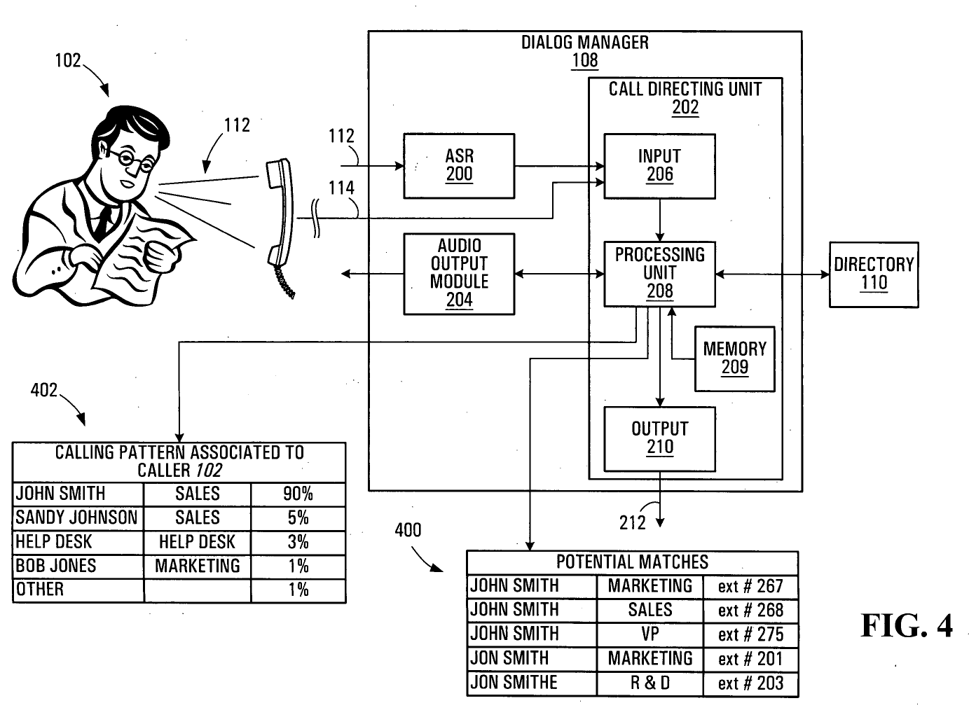

Referring back to FIG. 3, at step 309, in the case where there are multiple directory entries that are a potential match to the signal derived from the spoken utterance, the processing unit 208 proceeds to step 310. At step 310, the processing unit 208 selects one or more most likely directory entries from the multiple directory entries on the basis of a calling pattern. As will be described below, the calling pattern can be associated to either the caller 102, or to the directory entries in the directory 110. The use of the calling patterns will be described in more detail further on in the description with reference to FIGS. 4-7.

At step 311, if there is only one directory entry in the list of multiple directory entries that is a most likely match on the basis of a calling pattern, then the processing unit 208 proceeds to step 312 and routes the caller 102 to the most likely directory entry. As such, the dialog manager 108 might have the following interaction with the caller 102.
[dialog manager 108] For what name, please?
[caller 102] John Smith

Let us assume that there are five entries in the directory 110 that are a potential match to John Smith. However, based on the calling pattern, the processing unit 208 determines that the caller only calls the John Smith in the Parts department. As such, the dialog manager is able to route the call directly.
[dialog manager 108] Transferring your call to John Smith in Parts.
In an alternative embodiment, the dialog manager 108 can present the most likely match to the caller in order to obtain verbal confirmation from the caller 102, prior to transferring the call. For example:
[dialog manager 108] Would you like the John Smith in Parts?
[caller] Yes
[dialog manager 108] Transferring your call to John Smith in Parts.

Alternatively, if on the basis of a calling pattern, there is more than one most likely directory entry in the list of multiple directory entries, then the dialog manager 108 would need to continue a dialog with the caller 102, and would proceed to step 314. An example of such an interaction might occur as follows:
[dialog manager 108] For what name, please?
[caller] John Smith

Let us assume that in the calling pattern associated to the caller 102, there are two John Smiths that the caller 102 calls on a frequent basis, such that the processing unit 208 might not be able to confidently determine to which John Smith the caller would like to be directed. In such a case more information is required, and the interaction between the caller 102 and the dialog manager 108 might continue as follows:
[dialog manager 108] For John Smith in Sales?
[caller 102] No
[dialog manager 108] For John Smith in Parts?
[caller 102] Yes
[dialog manager 108] Transferring your call to John Smith in Parts.

At step 312, once the processing unit 308 has selected a most likely directory entry from the list of multiple directory entries that are a potential match to the signal derived from the spoken utterance, the processing unit 208 outputs a signal for causing the caller 102 to be directed to the most likely directory entry.

An expanded description of the process that occurs at step 310, will be described in further detail with respect to FIGS. 4 through 7.

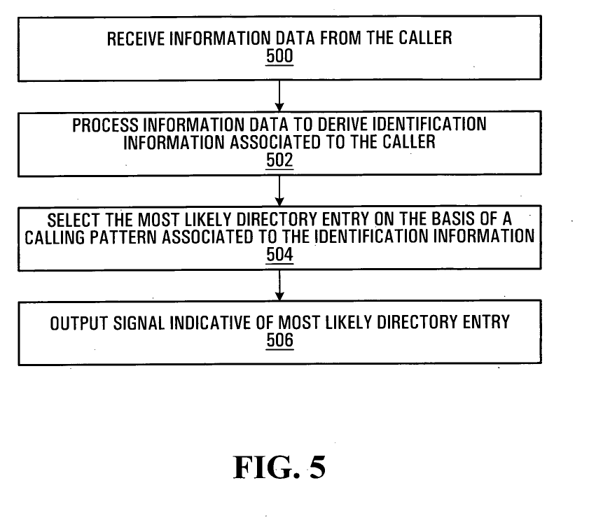

Shown in FIG. 4 is a first non-limiting example wherein the calling pattern, which is represented by table 402, is associated to the caller 102. In the example shown, the calling pattern 402 includes the names of the individuals and departments in the enterprise that that caller 102 has called in the past, the department the individuals work in, and a calling frequency data element associated to past calls made by the caller to each respective directory entry in the calling pattern. It should be understood that the calling frequency data element can include a percentage value indicative of the percentage of total calls made by the caller that have been routed to a respective directory entry, a number count indicative of the number of calls made by the caller to a respective directory entry, a probability/likelihood value that a caller will call the respective directory entry again, or a relative ranking, such as A, B, C, or 1, 2, 3 for ranking the most frequently called directory entries. Optionally, the calling pattern may also include a time data element associated to the calling frequency data element. The time data element may be indicative of the date/time the directory entry was last called by the caller. Also shown in FIG. 4 is a list of multiple directory entries 400, that are a potential match to the information derived from the caller's spoken utterance. Shown in FIG. 5 is a non-limiting example of a process implemented by the call-directing unit 202 for selecting a most likely directory entry from the multiple directory entries 400 on the basis of the calling pattern 402.

In addition to the calling pattern 402, FIG. 4 shows an example of a list of multiple directory entries 400 that have been identified by the processing unit 208 as being potential matches to the information derived from the spoken utterance. The fact that there are multiple directory entries 400 causes ambiguity. As such, the call-directing unit 202 makes use of additional information to identify a most likely directory entry.

More specifically, at step 500, the call-directing unit 202 receives information data from the caller 102 containing information associated to that caller 102. The information data can include an identification code provided by the caller 102, the caller's caller line ID (CLID), speaker recognition information, a combination of any of the above types of information, or any other suitable information associated with the caller 102. As shown in FIG. 4, this information data can be provided in a signal 114 that is separate from the signal 112 containing the caller's spoken utterance. As such, the signal 114 containing the information data can be received at input 206, or alternatively, can be received at a separate input (not shown). Alternatively, in the case where the information data is contained in the caller's spoken utterance, such as when the processing unit 208 uses speaker recognition techniques, such as speaker identification, to generate identification information, the information data can be provided in the same signal 112 as the caller's spoken utterance. Regardless of how the information data is received, both the information derived from the spoken utterance and the information data are passed to the processing unit 208.

At step 502, the processing unit 208 processes the information contained in the information data in order to derive identification information associated to the caller 102. For example, the identification information could be a code such as caller A, caller B, etc. . . . the caller's name, such as Mary Jones, or the caller's telephone number, among others. Once the processing unit 208 has derived identification information associated to the caller, the processing unit 208 determines whether there is a calling pattern that corresponds to that identification information. In the cases where the caller 102 is a first time caller, or an infrequent caller, it is unlikely that there will be a calling pattern associated to the identification information. Optionally, a default calling pattern for all new users can be used.

In the case where the caller 102 is a regular and frequent caller, there is a greater likelihood that there will be a calling pattern associated to the identification information. The manner in which calling patterns are generated will be described in greater detail further on in the specification.

In a non-limiting example of implementation, the calling patterns that correspond to the identification information associated to respective callers are stored in the memory 209 which is in communication with the processing unit 208. Once the processing unit 208 has derived identification information associated to the caller 102, the processing unit 208 can perform a look-up operation in the memory 209 in order to determine if there is a calling pattern associated to that identification information.

At step 504, once the processing unit 208 has identified that there is a calling pattern 402 associated to the caller 102, the processing unit 208 selects the most likely directory entry from the multiple directory entries 400 at least in part on the basis of the calling pattern 402. For example, on the basis of the calling pattern, the processing unit 208 determines whether caller 102 calls any of the individuals identified in the list multiple directory entries 400. For example, in a non-limiting embodiment, the processing unit 208 might compare the multiple directory entries 400 that are a potential match to the information derived from the spoken utterance with the information contained in the calling pattern 402. In so doing, the processing unit 208 is able to determine if any of the multiple directory entries 400 that are a potential match to the information derived from the spoken utterance have previously been called by the caller 102. For example, if the calling pattern contains a directory entry that is associated with a calling frequency data element having a high value, and that directory entry is contained in the list of multiple directory entries 400 that are a potential match to the information derived from the spoken utterance, then the processing unit 208 will consider that directory entry to be the most likely directory entry.

Referring to the non-limiting example shown in FIG. 4, based on the information contained in the calling pattern 402, the processing unit 208 would select the directory entry indicative of “John Smith” in sales as being the most likely directory entry. This is because the calling frequency data element contained in the calling pattern 402 indicates that 90% of the phone calls received from caller 102 have been routed to “John Smith”, and that the caller 102 has rarely, if ever, called any of the other directory entries in the list of multiple directory entries 400. As such, given that the call-directing unit 202 can determine based on the calling pattern 402 that the caller 102 asks for John smith in sales 90% of the time, there is a much higher probability that the caller 102 wants to talk to John Smith in sales, relative to the other directory entries contained in the list of multiple entries 400. Although the calling frequency data element has been indicated as a percentage value in this example, it should be understood that calling frequency data elements indicated in another fashion, such as via a count number, could also have been used without departing from the spirit of the invention.

It should be understood that the calculation, or selection, of the most likely directory unit made by the processing unit 208, can be made using heuristic rules, statistical computations, or any other method for conditioning the selection in favor of frequently called parties.

At step 506, the processing unit 208 releases a signal to output 210 indicative of the selected most likely directory entry. As such, the call-directing unit 202 is able to direct the caller 102 to the individual or department associated to the selected directory entry.

In an alternative non-limiting embodiment, in the cases where the information data is caller ID, or some other relatively easy type of information data, then the processing unit 208 is able to derive identification information associated to the caller relatively easily, and is able to determine if there is a calling pattern associated to the identification information before the ASR engine 200 is able to generate the recognition results derived from the spoken utterance.

In such an embodiment, wherein the caller 102 is identified prior to the ASR engine 200 generating recognition results, the ASR engine 200 is able to modify its language and/or grammar weights to account for the caller's most likely directory entries that are contained in the calling pattern associated to the caller. In this manner, it is more likely that the ASR engine 200 will recognize the individuals or departments most frequently called by the caller. Once the ASR 200 engine has generated information derived from the spoken utterance, with the help of the calling pattern associated to the caller, if there is only one directory entry that is a potential match to the signal, then the processing unit skips to step 510. However, if there are multiple entries that are a potential match to the signal derived from the spoken utterance, then the processing unit continues to step 508, and selects the most likely directory entry on the basis of the calling pattern associated to the caller. This process can be implemented by an algorithm including the following steps:
1. identifying the caller and locating the calling frequency data element indicative of the times the caller has been directed to certain entries in the directory 110.
2. Modifying the language model or grammar weights in the ASR engine 200 to account for this caller's most likely entries.
3. Recognizing one or more directory entries associated to the caller's spoken utterance;
4. If there is only one directory entry, transfer the caller to that entry;
5. If there is more than one directory entry but one of the possible entries is much more likely than the others, transfer the call to that entry;
6. Otherwise offer the caller the possible entries in order of the most likely first;
7. Update the caller's calling pattern, as will be described in more detail further on.

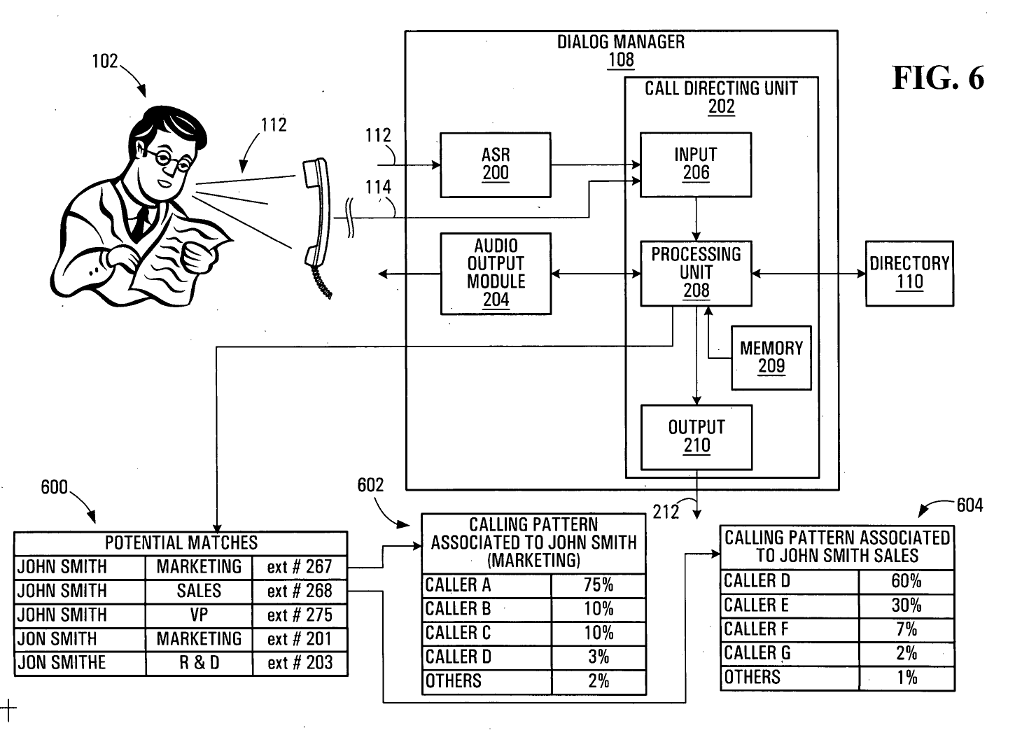

Shown in FIG. 6 is a second non-limiting example of implementation wherein calling patterns are associated to at least some of the directory entries in the directory 110. In this embodiment, the processing unit 208 determines whether one or more of the multiple directory entries in the list of multiple directory entries 600 receive calls from the caller 102. As such, this is determined once the ASR engine 200 has generated the recognition results derived from the spoken utterance.

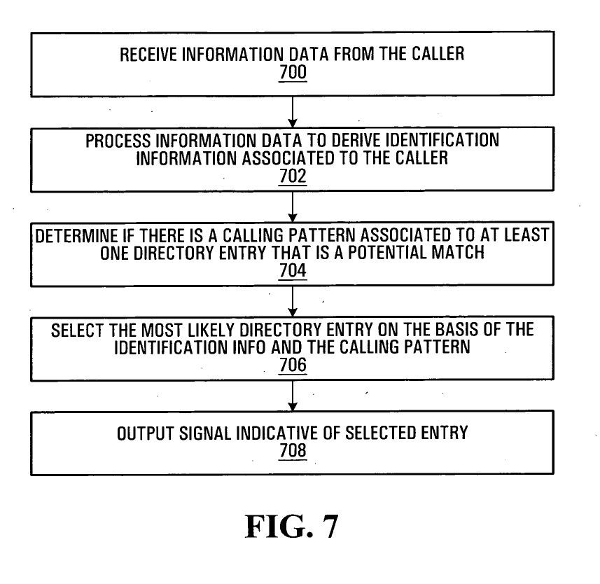

As shown in FIG. 6, the first and second directory entries in the list of multiple directory entries 600 are associated to respective calling patterns represented by tables 602 and 604. For the sake of simplicity, only two calling patterns 602 and 604 have been shown, however, it should be understood that each directory entry in the list of multiple directory entries 600 can be associated to a respective calling pattern. In the embodiment shown, the calling patterns 602, 604 include identification information associated to callers that have been routed to that directory entry in the past, and a calling frequency data elements associated to the frequency of calls to that directory entry that have been made from respective callers. A non-limiting procedure used by the call-directing unit 202 for selecting the most likely directory entry from the multiple directory entries 600 on the basis of the calling patterns 602 and 604, will be described with reference to FIG. 7.

In addition tot he calling patterns 602, 604, FIG. 6 shows an example of a list of multiple directory entries 600 that are a potential match to the information derived from the spoken utterance. The fact that there are multiple directory entries 600 causes ambiguity. As such, the call-directing unit 202 uses additional information to identify to which directory entry to direct the caller 102.

More specifically, at step 700, the call-directing unit 202 receives information data from the caller 102 containing information associated to that caller 102. The information data can include an identification code provided by the caller 102, the caller's caller line ID (CLID), speaker recognition information, a combination of any of the above types of information, or any other suitable information associated with the caller 102. As shown in FIG. 6, this information data can be provided in a signal 114 that is separate from the signal 112 containing the caller's spoken utterance. As such, the signal 114 containing the information data can be received at input 206, or alternatively, can be received at a separate input (not shown). Alternatively, in the case where the information data is contained in the caller's spoken utterance, such as when the processing unit 208 uses speaker recognition techniques, such as speaker identification, to generate identification information, the information data can be provided in the same signal 112 as the caller's spoken utterance. In one example of implementation, the processing unit 208 performs voice verification/identification techniques on the caller's speech in order to derive suitable identification information associated to the caller 102. Regardless of how the information data is received, both the information derived from the spoken utterance and the information data are passed to the processing unit 208.

At step 702, the processing unit 208 processes the information data in order to derive the identification information associated to the caller 102.

At step 704, the processing unit 208 determines whether there is a calling pattern associated to the multiple directory entries 600 that are potential matches to the information derived from the spoken utterance. The manner in which calling patterns are generated will be described in greater detail further on in the specification.

In a non-limiting example of implementation, each directory entry in the directory 110 has a corresponding calling pattern that is stored either in the directory 110, or in a memory 209 that is in communication with the processing unit 208. As such, once the processing unit 208 has identified the multiple directory entries that are potential matches to the spoken utterance at step 702, the processing unit 208 determines if there is a calling pattern associated to each one of the multiple directory entries 600. More specifically, the processing unit 208 determines if any of the multiple directory entries are frequently called by the caller 102. In the example shown in FIG. 6, there are calling patterns 602 and 604 associated to the first and second directory entries in the list of multiple directory entries 600.

At step 706, once the processing unit 208 has identified the calling patterns 602 and 604 associated to the directory entries in the multiple directory entries 600, the processing unit 208 selects the most likely directory entry from the multiple directory entries 600 at least in part on the basis of the calling patterns 602, 604 and the identification information associated to the caller. For example, the processing unit 208 determines based on the calling patterns associated with the directory entries, whether there is a directory entry that the caller is known to call. More specifically, the processing unit 208 compares the identification information associated with the caller 102 with the identification information contained in the calling patterns 602, 604. In so doing, the processing unit 208 is able to determine if any of the multiple directory entries 600 is regularly called by the caller 102. Referring to the non-limiting example shown in FIG. 6, and assuming that the processing unit 208 has derived identification information associated to caller 102 that identifies caller 102 as “caller E”, based on the information contained in the calling patterns 602 and 604, the processing unit 208 would select the directory entry indicative of “John Smith” in sales as being the most likely directory entry. This is because there is a history of caller E calling “John Smith” in sales and no history of caller E calling any of the other directory entries in the multiple directory entries 600. As such, there is a high probability that the caller 102 is calling “John Smith” in sales.

In an alternative embodiment, in the case where the calling patterns associated to the directory entries in the list of multiple directory entries 600 indicate that the caller 102 has called more than one of the directory entries in the list of multiple directory entries 600 in the past, then it is possible that the processing unit 208 will have more than one most likely directory entry. As such, the processing unit 208 can engage in further dialog with the caller 102 in order to resolve the ambiguity.

At step 708, once the processing unit 208 has determined a single directory entry that is a most likely match to the information derived from the spoken utterance, the processing unit 208 releases a signal to output 210 indicative of that directory entry. As such, the call-directing unit 202 is able to direct the caller 102 to the individual or department associated to the selected directory entry.

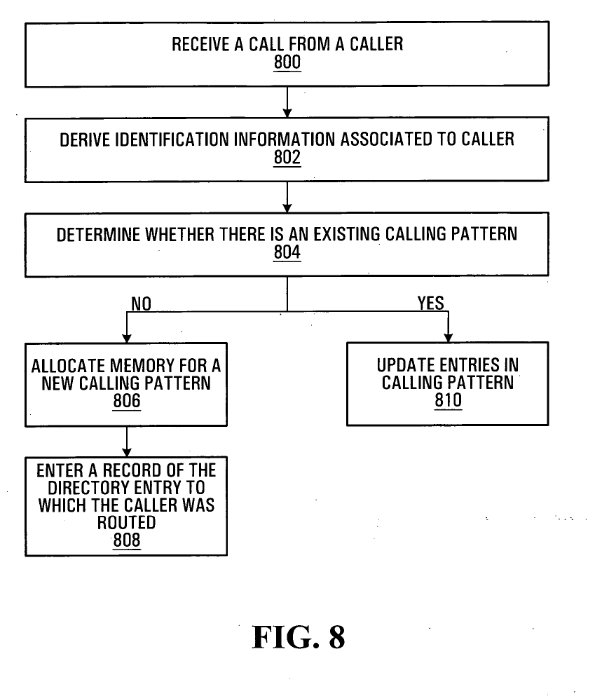

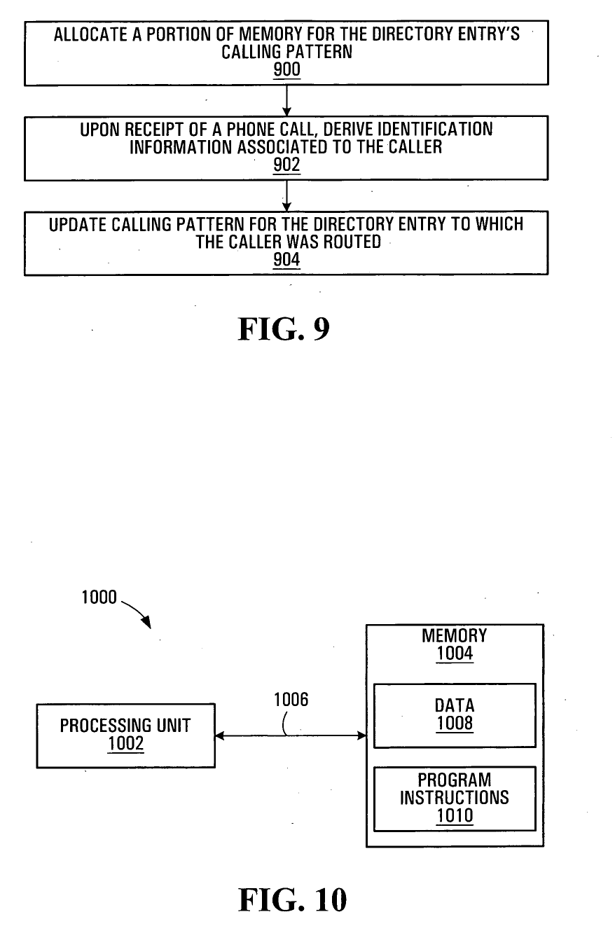

Shown in FIG. 8 is a non-limiting example of a process for generating calling patterns associated to a caller. Shown in FIG. 9 is a non-limiting example of a process for generating calling patterns associated to the directory entries in the directory 110.

As shown in FIG. 8, the first step 800 in a non-limiting process for generating a calling pattern associated to a caller 102, is to receive a call from a caller 102. At step 802, the processing unit 208 derives identification information associated to the caller based on information data received from the caller. As mentioned above, the identification information is any suitable identifier for identifying the caller 102.

At step 804, the processing unit 208 determines whether there is an existing calling pattern stored in the memory 209 that is associated to the identification information. At step 806, in the case where there is no calling pattern, the processing unit 208 allocates a portion of the memory for a new calling pattern that will correspond to the identification information for that caller. Once the caller 102 has been routed to one of the directory entries in the directory 110, at step 808 the processing unit 208 will enter a record of the directory entry to which the caller 102 was routed into the new calling pattern. As such, after the first phone call, the caller 102 will have a calling pattern containing the directory entry to which the caller was routed, and a calling frequency data element.

Alternatively, in the case where there is already a calling pattern associated with the identification information, at step 810, after the caller 102 has been routed to a directory entry, the processing unit 208 updates the information in the calling pattern. In the non-limiting example of implementation shown in FIG. 4, the calling pattern associated to the caller includes the names of the individuals or departments to which the caller has been routed, and a calling frequency data element. As such, with each new call from caller 102, the calling pattern can be updated to add a new directory entry, in the case where the caller has never called that directory entry before, and/or can be updated to readjust the calling frequency data element. The value of the calling frequency data element, which can be associated with the probability of a caller calling each directory entry in the calling pattern, can be calculated based on known counting techniques. In a first example of implementation, the calling frequency data element can be calculated based on a total number of calls T made by the caller 102, and the number of times t the caller has called a specific directory entry. As such, with each new call the value of T is updated to equal T+1.

In a second example of implementation, the calling frequency data elements are calculated based on a circular buffer that considers a predefined number of calls N made by the caller 102. As such, once the caller makes an N+1 call, the information contained in the first call is dropped. This helps to reduce the amount of memory required by the call-directing unit 202. In a non-limiting example, if the predetermined number of calls is N, and the number of times the caller has called a specific directory entry is n, then the calling frequency data element value associated to that directory entry may be n/N.

It should be understood that the manner in which the processing unit 208 considers the calling frequency data elements in order to determine a most likely match is not a limiting feature of the present invention. For example, in the case where the calling frequency data elements include a percentage, the processing unit might only consider the directory entry to be a most likely match if the percentage value is above 70%. Alternatively, in the case where the calling frequency data element include a simple count value, the processing unit might compare the highest count values to the lower count values in order to determine if a directory is a frequently called directory entry.

In a further non-limiting embodiment, in order to conserve memory, it is possible for the processing unit 208 to date and time stamp the calling pattern, such that if a calling pattern has not been updated within a predetermined amount of time, the calling pattern is deleted from memory. This will result in a memory that stores calling patterns for regular and frequent callers. Alternatively, each entry in the calling pattern can be date and time stamped each time a caller is routed to that directory entry, such that if that entry is not called within a predetermined amount of time, the entry is dropped. If the caller does not call any of the entries in his/her calling pattern within the predetermined amount of time, the calling pattern will be deleted such that there will be no calling pattern associated to that caller.

Referring now to FIG. 9, the first step 900 in a non-limiting process for generating calling patterns associated to the directory entries in the directory 110, is to allocate a portion of memory 209 for each directory entry's calling pattern. The memory allocated for each calling pattern will store a record of the callers 102 that have been routed to the directory entry to which the calling pattern is associated. At step 902, upon receipt of a phone call from a caller 102 the processing unit 208 derives identification information for that caller based on information data received from the caller 102.

At step 904, once the processing unit 208 has determined to which directory entry the caller 102 should be routed, the processing unit 208 updates the calling pattern of the directory entry to which the caller 102 was routed. In the non-limiting example of implementation shown in FIG. 6, the calling patterns associated to the directory entries include, identification information associated to the callers that have been routed to that directory entry, and a calling frequency data element indicative of the frequency of the calls to that directory entry that have been made by each of the callers. As such, with each new call that is routed to a respective directory entry, the processing unit 208 updates that directory entry's calling pattern. The calling pattern can be updated to add/remove a caller to the list and/or can be updated to readjust the calling frequency data element. In a first example of implementation, the calling frequency data element can be calculated based on every call the directory entry receives, and in a second example of implementation, the calling frequency data element can be calculated based on a set number of calls, such as the last 10 calls that the directory entry received.

Those skilled in the art should appreciate that in some embodiments of the invention, all or part of the functionality previously described herein with respect to the dialog manager 108 may be implemented as pre-programmed hardware or firmware elements (e.g., application specific integrated circuits (ASICs), electrically erasable programmable read-only memories (EEPROMs), etc.), or other related components.

In other embodiments of the invention, all or part of the functionality previously described herein with respect to the dialog manager 108 may be implemented as software consisting of a series of instructions for execution by a computing unit. The series of instructions could be stored on a medium which is fixed, tangible and readable directly by the computing unit, (e.g., removable diskette, CD-ROM, ROM, PROM, EPROM or fixed disk), or the instructions could be stored remotely but transmittable to the computing unit via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

The computing unit implementing the dialog manager 108 may be configured as a computing unit 1000 of the type depicted in FIG. 10, including a processing unit 1002 and a memory 1004 connected by a communication bus 1006. The memory 1004 includes data 1008 and program instructions 1010. The processing unit 1002 is adapted to process the data 1008 and the program instructions 1010 in order to implement the functionality described in the specification and depicted in the drawings. The computing unit 1000 may also comprise an I/O interface for receiving or sending data elements to external devices. For example, the I/O interface may be used for receiving and sending the speech signals processed by the methods described in this specification, and for releasing the called party information.

Those skilled in the art should further appreciate that the program instructions 1008 may be written in a number of programming languages for use with many computer architectures or operating systems. For example, some embodiments may be implemented in a procedural programming language (e.g., “C”) or an object oriented programming language (e.g., “C++” or “JAVA”).

The above description of embodiments should not be interpreted in a limiting manner since other variations, modifications and refinements are possible within the spirit and scope of the present invention. The scope of the invention is defined in the appended claims and their equivalents.

1. A method for identifying a called party, said method comprising:
(a) receiving information derived from a spoken utterance by a caller;
(b) deriving identification information associated to the caller;
(c) processing the information derived from the spoken utterance on the basis of a plurality of directory entries to identify at least one directory entry that is a potential match to the information derived from the spoken utterance;
(d) when multiple directory entries in the plurality of directory entries are potential matches to said information, said method comprises identifying a calling pattern associated to said identification information, and selecting a most likely directory entry from the multiple directory entries at least in part on the basis of the calling pattern;
(e) releasing a signal conveying the most likely directory entry.

2. A method as defined in claim 1, wherein said identification information includes caller line ID.

3. A method as defined in claim 1, wherein said identification information is generated on the basis of the spoken utterance.

4. A method as defined in claim 1, wherein said calling pattern includes a plurality of entries associated to respective directory entries to which the caller has been routed, each entry including a calling frequency data element.

5. A method as defined in claim 4, wherein said calling pattern includes a calling frequency data element conveying a count of the number of times the caller has called the directory entry.

6. A method as defined in claim 4, wherein said calling pattern includes a calling frequency data element conveying a percentage value.

7. A method as defined in claim 4, wherein said calling pattern includes a calling frequency data element conveying a ranking.

8. A method as defined in claim 1, wherein said calling pattern includes a data element indicative of a time data element.

9. An apparatus for identifying a called party, said apparatus comprising:
(a) an input for receiving information derived from a spoken utterance by a caller;
(b) a processing unit in communication with said input, said processing unit being operative for:
i) deriving identification information associated to the caller;
ii) processing the information derived from the spoken utterance on the basis of a plurality of directory entries to identify at least one directory entry that is a potential match to the information derived from the spoken utterance;
iii) when multiple directory entries in the plurality of directory entries are potential matches to the information derived from the spoken utterance, said processing unit identifies a calling pattern associated to said identification information and selects a most likely directory entry from the multiple directory entries at least in part on the basis of the calling pattern;
(c) an output for releasing a signal conveying the most likely directory entry.

10. An apparatus as defined in claim 9, wherein said identification information includes caller line ID.

11. An apparatus as defined in claim 9, wherein said identification information is generated on the basis of the spoken utterance.

12. An apparatus as defined in claim 9, wherein said calling pattern includes a plurality of entries associated to respective directory entries to which the caller has been routed, each entry including a calling frequency data element.

13. An apparatus as defined in claim 12, wherein said calling pattern includes a calling frequency data element conveying a count of the number of times the caller has called the directory entry.

14. An apparatus as defined in claim 12, wherein said calling pattern includes a calling frequency data element conveying a percentage value.

15. An apparatus as defined in claim 12, wherein said calling pattern includes a calling frequency data element conveying a ranking.

16. An apparatus as defined in claim 9, wherein said calling pattern includes a data element indicative of a time data element.

17. A computer readable storage medium including a program element suitable for execution by a computing apparatus for identifying a called party, said computing apparatus comprising:
(a) a memory unit;
(b) a processor operatively connected to said memory unit, said program element when executing on said processor being operative for:
i) receiving information derived from a spoken utterance by a caller;
ii) deriving identification information associated to the caller;
iii) processing the information derived from the spoken utterance on the basis of a plurality of directory entries to identify at least one directory entry that is a potential match to the information derived from the spoken utterance;
iv) when multiple directory entries in the plurality of directory entries are potential matches to said information, said processor being operative for identifying a calling pattern associated to said identification information, and selecting a most likely directory entry from the multiple directory entries at least in part on the basis of the calling pattern;
v) releasing a signal conveying the most likely directory entry.

18. A computer readable storage medium as defined in claim 17, wherein said identification information includes caller line ID.

19. A computer readable storage medium as defined in claim 17, wherein said identification information is generated on the basis of the spoken utterance.

20. A computer readable storage medium as defined in claim 17, wherein said calling pattern includes a plurality of entries associated to respective directory entries to which the caller has been routed, each entry including a calling frequency data element.

21. A computer readable storage medium as defined in claim 20, wherein said calling pattern includes a calling frequency data element conveying a count of the number of times the caller has called the directory entry.

22. A computer readable storage medium as defined in claim 20, wherein said calling pattern includes a calling frequency data element conveying a percentage value.

23. A computer readable storage medium as defined in claim 20, wherein said calling pattern includes a calling frequency data element conveying a ranking.

24. A computer readable storage medium as defined in claim 17, wherein said calling pattern includes a data element indicative of a time data element.

25. A method for identifying a called party, said method comprising:
(a) receiving information derived from a spoken utterance by a caller;
(b) deriving identification information associated to the caller;
(c) processing the information derived from the spoken utterance on the basis of a plurality of directory entries to identify at least one directory entry that is a potential match to the information derived from the spoken utterance;
(d) when multiple directory entries in the plurality of directory entries are potential matches to the information derived from the spoken utterance, said method comprises identifying a calling pattern associated to each of said directory entries that is a potential match to the information derived from the spoken utterance, and selecting a most likely directory entry from the multiple directory entries at least in part on the basis of:
i) said identification information; and
ii) the calling patterns associated to the entries in said multiple directory entries;
(e) releasing a signal conveying the most likely directory entry.

26. A method as defined in claim 25, wherein said identification information includes caller line ID.

27. A method as defined in claim 25, wherein said identification information is generated on the basis of the spoken utterance.

28. A method as defined in claim 25, wherein each of the calling patterns includes a plurality of entries associated to respective callers who have been routed to the directory entry.

29. A method as defined in claim 28, wherein each of said calling patterns includes a calling frequency data element conveying a count of the number of times the respective callers have called the directory entry.

30. A method as defined in claim 28, wherein each of said calling patterns includes a calling frequency data element conveying a percentage value.

31. A method as defined in claim 28, wherein each of said calling patterns includes a calling frequency data element conveying a ranking.

32. A method as defined in claim 25, wherein each calling pattern includes a data element indicative of a time data element.

33. An apparatus for identifying a called party, said apparatus comprising:
(a) an input for receiving information derived from a spoken utterance by a caller;
(b) a processing unit in communication with said input, said processing unit being operative for:
i) deriving identification information associated to the caller;
ii) processing the information derived from the spoken utterance on the basis of a plurality of directory entries to identify at least one directory entry that is a potential match to the information derived from the spoken utterance;
iii) when multiple directory entries in the plurality of directory entries are potential matches to the information derived from the spoken utterance, said processing unit identifies a calling pattern associated to each of said directory entries that is a potential match to the information derived from the spoken utterance and selects a most likely directory entry from the multiple directory entries at least in part on the basis of:
1) said identification information; and
2) calling patterns associated to the entries in said multiple directory entries;
(c) an output for releasing a signal conveying the most likely directory entry.

34. An apparatus as defined in claim 33, wherein said identification information includes caller line ID.

35. An apparatus as defined in claim 33, wherein said identification information is generated on the basis of the spoken utterance.

36. An apparatus as defined in claim 33, wherein each of the calling patterns includes a plurality of entries associated to respective callers who have been routed to the directory entry.

37. An apparatus as defined in claim 36, wherein each of said calling patterns includes a calling frequency data element conveying a count of the number of times the respective callers have called the directory entry.

38. An apparatus as defined in claim 36, wherein each of said calling patterns includes a calling frequency data element conveying a percentage value.

39. An apparatus as defined in claim 36, wherein each of said calling patterns includes a calling frequency data element conveying a ranking.

40. An apparatus as defined in claim 33, wherein each calling pattern includes a data element indicative of a time data element.

41. A computer readable storage medium including a program element suitable for execution by a computing apparatus for identifying a called party, said computing apparatus comprising:
(a) a memory unit;
(b) a processor operatively connected to said memory unit, said program element when executing on said processor being operative for:
i) receiving information derived from a spoken utterance by a caller;
ii) deriving identification information associated to the caller;
iii) processing the information derived from the spoken utterance on the basis of a plurality of directory entries to identify at least one directory entry that is a potential match to the information derived from the spoken utterance;
iv) when multiple directory entries in the plurality of directory entries are potential matches to said information derived from the spoken utterance, said processor being operative for identifying a calling pattern associated to each of said directory entries that is a potential match to the information derived from the spoken utterance, and selecting a most likely directory entry from the multiple directory entries at least in part on the basis of:
1) said identification information;
2) the calling patterns associated to the entries in said multiple directory entries;
v) releasing a signal conveying the most likely directory entry.

42. A computer readable storage medium as defined in claim 41, wherein said identification information includes caller line ID.

43. A computer readable storage medium as defined in claim 41, wherein said identification information is generated on the basis of the spoken utterance.

44. A computer readable storage medium as defined in claim 41, wherein said calling pattern includes a plurality of entries associated to respective directory entries to which the caller has been routed, each entry including a calling frequency data element.

45. A computer readable storage medium as defined in claim 44, wherein said calling pattern includes a calling frequency data element conveying a count of the number of times the caller has called the directory entry.

46. A computer readable storage medium as defined in claim 44, wherein said calling pattern includes a calling frequency data element conveying a percentage value.

47. A computer readable storage medium as defined in claim 44, wherein said calling pattern includes a calling frequency data element conveying a ranking.

48. A computer readable storage medium as defined in claim 41, wherein said calling pattern includes a data element indicative of a time data element.

49. A method for identifying a called party, said method comprising:
(a) providing a directory including a plurality of entries, the directory including at least one set of phonetically similar entries;
(b) receiving information derived from a spoken utterance by a caller;
(c) generating identification information associated to the caller;
(d) processing the information derived from the spoken utterance on the basis of the directory to identify at least one entry that is a potential match to the information derived from the spoken utterance;
(e) when multiple entries in said set of phonetically similar entries are potential matches to the information derived from the spoken utterance, said method comprising selecting a most likely entry from the set of phonetically similar entries at least in part on the basis of said identification information;
(f) releasing a signal conveying the most likely directory entry.

50. A method as defined in claim 49, wherein said identification information is associated to a calling pattern.

51. A method as defined in claim 50, wherein said identification information includes caller line ID.

52. A method as defined in claim 50, wherein said identification information is generated on the basis of the spoken utterance.

53. A method as defined in claim 49, wherein each of the entries in said set of phonetically similar entries are associated to a calling pattern.

54. A method as defined in claim 53, wherein each of the calling patterns includes a plurality of entries associated to respective callers who have been routed to the directory entry.

55. A method as defined in claim 54, wherein each of said calling patterns includes a calling frequency data element conveying a count of the number of times the respective callers have called the directory entry.

56. A method as defined in claim 54, wherein each of said calling patterns includes a calling frequency data element conveying a percentage value.

57. A method as defined in claim 54, wherein each of said calling patterns includes a calling frequency data element conveying a ranking.

58. A method as defined in claim 53, wherein each calling pattern includes a data element indicative of a time data element.

59. An apparatus for directing incoming calls, said apparatus comprising:
(a) a memory unit for storing a directory including a plurality of entries, the directory including at least one set of phonetically similar entries;
(b) an input for receiving information derived from a spoken utterance by a caller;
(c) a processing unit in communication with said input and said memory unit, said processing unit being operative for:
i) generating identification information associated to the caller;
ii) processing the information derived from the spoken utterance on the basis of the directory to identify at least one entry that is a likely match to the information derived from the spoken utterance;
iii) when an entry is said set of phonetically similar entries is a likely match to the information derived from the spoken utterance, said processing unit selects a most likely entry from the set of phonetically similar entries at least in part on the basis of said identification information;
(d) an output for releasing a signal conveying the most likely directory entry.

60. An apparatus as defined in claim 59, wherein said identification information is associated to a calling pattern.

61. An apparatus as defined in claim 60, wherein said identification information includes caller line ID.

62. An apparatus as defined in claim 60, wherein said identification information is generated on the basis of the spoken utterance.

63. An apparatus as defined in claim 59, wherein each of the entries in said set of phonetically similar entries are associated to a calling pattern.

64. An apparatus as defined in claim 63, wherein each of the calling patterns includes a plurality of entries associated to respective callers who have been routed to the directory entry.

65. An apparatus as defined in claim 64, wherein each of said calling patterns includes a calling frequency data element conveying a count of the number of times the respective callers have called the directory entry.

66. An apparatus as defined in claim 64, wherein each of said calling patterns includes a calling frequency data element conveying a percentage value.

67. An apparatus as defined in claim 64, wherein each of said calling patterns includes a calling frequency data element conveying a ranking.

68. An apparatus as defined in claim 63, wherein each calling pattern includes a data element indicative of a time data element.

69. A computer readable storage medium including a program element suitable for execution by a computing apparatus for identifying a called party, said computing apparatus comprising:
(a) a memory unit;
(b) a processor operatively connected to said memory unit, said program element when executing on said processor being operative for:
i) providing a directory including a plurality of entries, the directory including at least one set of phonetically similar entries;
ii) receiving information derived from a spoken utterance by a caller;
iii) generating identification information associated to the caller;
iv) processing the information derived from the spoken utterance on the basis of a plurality of directory entries to identify at least one entry that is a potential match to the information derived from the spoken utterance;
v) when multiple directory entries in the set of phonetically similar entries are potential matches to the information derived from the spoken utterance, said processor being operative for selecting a most likely directory entry from the set of phonetically similar entries at least in part on the basis of said identification information;
vi) releasing a signal conveying the most likely directory entry.

70. A method for identifying a called party, said method comprising:
(a) receiving an utterance spoken by a caller;
(b) identifying a set of directory entries that are a potential match to the utterance spoken by the caller;
(c) deriving identification information associated to the caller, said identification information corresponding with a calling pattern;
(d) selecting a most likely directory entry from the set of directory entries at least in part on the basis of the calling pattern;
(e) releasing a signal conveying the most likely directory entry.

71. A method for identifying a called party, said method comprising:
(a) receiving an utterance spoken by a caller;
(b) identifying a set of directory entries that are a potential match to the utterance spoken by the caller;
(c) deriving identification information associated to the caller;
(d) identifying a calling pattern associated to at least one of the directory entries that is a potential match to the spoken utterance;
(e) selecting a most likely directory entry from the set of directory entries at least in part on the basis of the calling patterns;
(f) releasing a signal conveying the most likely directory entry.

72. A method for identifying a called party, said method comprising:
(a) receiving an utterance spoken by a caller;
(b) identifying a set of phonetically similar directory entries, each entry in said set being a potential match to the utterance spoken by the caller;
(c) deriving identification information associated to the caller;
(d) selecting a most likely entry from the set of phonetically similar directory entries at least in part on the basis of the identification information;
(e) releasing a signal conveying the most likely directory entry.

73. A system for identifying a called party, said system comprising:
(a) an automated speech recognition engine adapted for processing an utterance spoken by a caller for deriving information therefrom;
(b) a call directing unit in communication with said speech recognition engine, said call directing unit comprising:
i) an input for receiving the information derived from the spoken utterance;
ii) a processing unit in communication with said input, said processing unit being operative for:
1) deriving identification information associated to the caller;
2) processing the information derived from the spoken utterance on the basis of a plurality of directory entries to identify at least one directory entry that is a potential match to the information derived from the spoken utterance;
3) when multiple directory entries in the plurality of directory entries are potential matches to the information derived from the spoken utterance, said processing unit identifies a calling pattern associated to said identification information and selects a most likely directory entry from the multiple directory entries at least in part on the basis of the calling pattern;
iii) an output for releasing a signal conveying the most likely directory entry.

74. A system as defined in claim 73, wherein said call directing unit is operative for transferring the caller to said most likely directory entry.

75. An apparatus for identifying a called party, said apparatus comprising:
(a) means for receiving information derived from a spoken utterance by a caller;
(b) means for deriving identification information associated to the caller;
(c) means for processing the information derived from the spoken utterance on the basis of a plurality of directory entries to identify at least one directory entry that is a potential match to the information derived from the spoken utterance;
(d) means for identifying a calling pattern associated to said identification information and selecting a most likely directory entry from the multiple directory entries at least in part on the basis of the calling pattern, when multiple directory entries in the plurality of directory entries are potential matches to the information derived from the spoken utterance;
(e) means for releasing a signal conveying the most likely directory entry.
